(19) United States
(12) Patent Application Publication
(10) Pub. No.: US 2026/0286990 A1
(43) Pub. Date: Sep. 24, 2026

(54) HIGHLY STABLE AND CONTROLLABLE TEST DEVICE AND METHOD FOR LOW-SPEED STABILITY OF HYDRAULIC ROTARY ACTUATOR

(71) Applicant: ZHEJIANG UNIVERSITY, Hangzhou (CN)

(72) Inventors: Chao ZHANG, Hangzhou (CN); Yu FANG, Hangzhou (CN); Shuangjia LIU, Hangzhou (CN); Weidi HUANG, Hangzhou (CN); Junhui ZHANG, Hangzhou (CN); Bing XU, Hangzhou (CN)

(73) Assignee: ZHEJIANG UNIVERSITY, Hangzhou (CN)

(21) Appl. No.: 19/672,828

(22) Filed: May 11, 2026

Related U.S. Application Data
(63) Continuation of application No. PCT/CN2025/098828, filed on Jun. 3, 2025.

(30) Foreign Application Priority Data
Dec. 16, 2024 (CN) 202411845440.7

(51) Int. Cl. F15B 19/00

(52) U.S. Cl. CPC F15B 19/00

(57) ABSTRACT

The provided is a highly stable and controllable test device and method for low-speed stability of a hydraulic rotary actuator. The test device includes a mechanical system, a hydraulic system, and an electrical system, where the mechanical system includes a rack, a winch, a twisted rope, and the like; the hydraulic system includes a hydraulic cylinder, a tested component, a fixed-displacement radial piston pump, and the like; and the electrical system includes a load feedback system and a flow rate feedback system. According to the test device, while the highly controllable hydraulic winch based on the hydraulic cylinder is designed to provide the stable loading torque, a proportional servo-hydraulic system is established. The two-stage flow rate controller can greatly improve the stability of the loading torque and the input flow rate.

### CROSS-REFERENCE TO THE RELATED APPLICATIONS

This application is a continuation application of International Application No. PCT/CN2025/098828, filed on Jun. 3, 2025, which is based upon and claims priority to Chinese Patent Application No. 202411845440.7, filed on Dec. 16, 2024, the entire contents of which are incorporated herein by reference.

### TECHNICAL FIELD

The present disclosure belongs to the technical field of testing on high-performance hydraulic components, and in particular to a highly stable and controllable test device and method for low-speed stability of a hydraulic rotary actuator.

### BACKGROUND

Hydraulic rotary actuators are a type of component that converts hydraulic pressure energy into mechanical energy to drive working mechanisms, including but not limited to such hydraulic components as internal-curve hydraulic motors, gear motors, and vane motors. The hydraulic rotary actuators often exhibit higher power density than electric motors, and thus are widely used as core drive components in low-speed and high-torque rotating systems, such as screw conveyor systems of shield machines that are considered as national key equipment, cutter (bucket wheel) drive systems of dredgers that are considered as island-building artifacts, sonar towing systems on ships/scientific research vessels, and aerospace equipment. Their performance directly affects operation performance of the entire application systems. Comprehensive performance test is crucial for hydraulic components before installation at the original equipment manufacturer (OEM) as well as during system fault diagnosis and maintenance.

Stability refers to the speed pulsation of the hydraulic components at low speeds, and it has great significance for the high-torque hydraulic rotary actuator. On one hand, low-speed stability is determined by the nonlinear leakage and friction, as well as the structure design of the hydraulic rotary actuator, under low-speed and high-torque conditions. Thus, it can be a reflection of the inherent characteristics of the hydraulic rotary actuator. On the other hand, low-speed instability can also lead to output torque pulsation, affecting both the position and force control accuracy of the hydraulic rotary actuator. Therefore, testing the low-speed stability is important for revealing the inherent characteristics and evaluating the output performance of the hydraulic rotary actuator.

At present, there are three loading methods for testing the low-speed stability of the hydraulic rotary actuator: mechanical loading, electrical loading, and hydraulic loading. The mechanical loading method generally utilizes the weights to generate loading torque, which can be rather stable. However, the loading torque is hard to adjust continuously. Installing, handling and precisely adjusting these weights are difficult under high-torque conditions. The configuration is complex, and intricate balance valves and related hydraulic circuits are needed to prevent the weights from dropping suddenly. Thus, the mechanical loading method is rarely used. The electrical loading method includes electrical motor loading and magnetic powder brake loading. The electrical loading method can adjust the loading torque by changing the current. However, neither electrical motors nor magnetic powder brakes can achieve stable torque output at ultra-low speeds below 1 r/min. The loading torque generated by the electrical loading method is generally smaller than the hydraulic method owing to the high power density of the hydraulic components. Therefore, to test the high-torque hydraulic rotary actuator, the hydraulic loading method is more suitable. Currently, the hydraulic testing method uses identical hydraulic rotary actuator components to conduct counter-torque loading tests under pump operating conditions. However, due to unavoidable coupling between the speed pulsation and the torque pulsation of the loading components, the loading torque at the low speed is difficult to control, and the flow rate pulsation increases as the rotational speed decreases. Besides the aforementioned test methods, there is no suitable technology for testing the ultra-low-speed stability of the high-torque hydraulic rotary actuator.

### SUMMARY

In view of problems of existing test methods for low-speed stability of hydraulic rotary actuators at present, the present disclosure provides a highly stable and controllable test device and method for low-speed stability of a hydraulic rotary actuator. A highly controllable hydraulic winch based on a hydraulic cylinder is designed to generate a stable loading torque, while a proportional servo-hydraulic system is established to ensure a stable input flow rate. With a two-stage flow rate controller, a more stable loading torque and a more stable input flow rate can be achieved compared with the traditional method. The test device achieves higher accuracy and higher low-speed measurement capacity based on the more stable loading torque and input flow rate, thereby testing the low-speed stability. The above three design improvements can effectively realize accurate stability testing for the high-torque and ultra-low speed hydraulic rotary actuator.

The above objective of the present disclosure is achieved with the following technical solutions: A highly stable and controllable test device for low-speed stability of a hydraulic rotary actuator includes a mechanical system, a flow rate feedback system, and a load feedback system, where
the mechanical system is configured to convert a loading force of a hydraulic cylinder into a loading torque, and transmit the loading torque to a tested component through a torque sensor;
the load feedback system includes the torque sensor and a displacement sensor; the torque sensor is configured to measure a feedback signal of the loading torque applied to the tested component, and perform feedback control on the loading force provided by the hydraulic cylinder; the displacement sensor is configured to measure a displacement of the hydraulic cylinder; and a limit switch is provided to control a stroke of the hydraulic cylinder; and
the flow rate feedback system is configured to determine a desired flow rate and an incremental flow rate based on a flow rate at an inlet port and a flow rate at an outlet port, perform rough adjustment on a hydraulic flow rate provided by the hydraulic cylinder, and then perform fine adjustment on the hydraulic flow rate based on the desired flow rate.

Further, the mechanical system further includes a rack, a winch, a twisted rope, and a crown gear coupling; the hydraulic cylinder is disposed on the rack; the stroke of the hydraulic cylinder enables the winch and the tested component to complete more than one full rotation; the loading force generated by the hydraulic cylinder is converted into the loading torque by the winch; the hydraulic cylinder is connected to the winch through the twisted rope; the winch is connected to the tested component through the torque sensor; and the crown gear coupling is configured to compensate for possible angular misalignment.

Further, the hydraulic system includes a loading circuit of the hydraulic cylinder as well as a drive circuit and a flushing circuit of the tested hydraulic component;
the loading circuit is configured to output hydraulic oil through a loading fixed-displacement hydraulic pump, where a hydraulic pressure is adjusted by a loading proportional relief valve, and extension and retraction of the hydraulic cylinder are switched by a direction valve;
in the drive circuit, high-pressure oil is input by a driving fixed-displacement hydraulic pump to drive the tested component, low-pressure oil outflows to an oil tank, an input flow rate of the hydraulic oil is adjusted by a proportional servo direction valve, and a drain port on the tested component is connected to the oil tank; and
in the flushing circuit, flushing oil is provided for a flushing port of the tested component by a flushing fixed-displacement hydraulic pump, ensuring a thermal balance of the tested component in long-period operation.

Further, a safety proportional relief valve is connected in parallel to a high-pressure oil line of the loading circuit to serve as a safety valve.

Further, a pressure-adjusting proportional relief valve is connected in series to a low-pressure oil line to adjust an outlet oil pressure of the tested component.

Further, the limit switch is provided for the hydraulic cylinder according to the displacement of the hydraulic cylinder measured by the displacement sensor; the limit switch is configured to set a test stroke of the hydraulic cylinder; and when the hydraulic cylinder reaches a stroke limit, in order not to damage the hydraulic cylinder due to continuous pressure application, a value of a needed loading torque is set as zero; otherwise, a torque is output to realize the feedback control.

Further, the flow rate feedback system is configured to adjust an output flow rate in two stages; in a first stage, a needed incremental flow rate is measured through an oil inlet flowmeter and an oil outlet flowmeter, a flow rate output by the driving fixed-displacement hydraulic pump is determined based on the desired flow rate and the needed incremental flow rate to perform rough adjustment on the flow rate, and the flow rate is greater than a needed flow rate; then, in a second stage, fine adjustment is performed through a proportional-integral (PI) controller based on the desired flow rate to adjust the flow rate to a desired value; and a control signal of valve opening of the proportional servo direction valve dynamically changes based on a signal of the oil inlet flowmeter, so as to keep the flow rate accurate and stable.

Further, the flow rate feedback system further includes a rotary encoder configured to measure information on a rotation angle of the tested component.

Further, the limit switch is configured to set the test stroke of the hydraulic cylinder; and set the value of the needed loading torque and the needed flow rate as zero when the hydraulic cylinder reaches the stroke limit.

In another aspect, the present disclosure further provides a highly stable and controllable testing method for low-speed stability of a hydraulic rotary actuator, including following steps:
(1) converting, by the mechanical system, the loading force of the hydraulic cylinder into the loading torque, and transmitting the loading torque to the tested component through the torque sensor;
(2) providing the limit switch, measuring the displacement of the hydraulic cylinder by the displacement sensor, and when the hydraulic cylinder reaches the stroke limit, setting the value of the needed loading torque and the needed flow rate as zero;
(3) based on the feedback signal of the loading torque measured by the torque sensor, controlling the loading torque provided by the hydraulic cylinder with a proportional-integral-derivative (PID) control algorithm;
(4) determining the desired flow rate and the incremental flow rate based on the flow rate at the inlet port and the flow rate at the outlet port, and performing the rough adjustment on the hydraulic flow rate provided by the hydraulic system; and
(5) adjusting the flow rate to the desired value through the PI controller based on the desired flow rate, and dynamically controlling the valve opening of the proportional servo direction valve based on the signal of the oil inlet flowmeter, so as to keep the flow rate accurate and stable.

The present disclosure has following beneficial effects:
To test ultra-low speed stability of the high-torque hydraulic rotary actuator, the present disclosure provides the highly stable and controllable hydro-mechatronic test device. The test device is provided with the highly controllable hydraulic winch based on the hydraulic cylinder, such that the loading torque generated by the hydraulic cylinder is stable and controllable. Since the configuration and friction pair in the hydraulic cylinder are far less complex than those in the loading hydraulic rotary actuator, and the loading speed of the hydraulic cylinder is very stable, the coupling between speed pulsation and torque pulsation of the loading component is greatly prevented, realizing stable control on the loading torque. According to the test device, the driving fixed-displacement hydraulic pump of the reverse-driven motor is used to replace the variable pump in the traditional test device. The rotational speed of the motor is controlled with the feedback signal of the flow rate. The driving fixed-displacement hydraulic pump outputs the flow rate, thereby reducing flow rate pulsation from the perspective of the component. The test device is provided with a two-stage flow rate controller, which can effectively control stability of the input flow rate to reduce the flow rate pulsation. While the loading torque and the input flow rate are more stable, the testing precision of the low-speed stability can be higher.

### BRIEF DESCRIPTION OF THE DRAWINGS

FIG. 1 is a hydraulic principle diagram of a highly stable and controllable test device for low-speed stability of a hydraulic rotary actuator;
in the figure: 1: hydraulic cylinder, 2: rack, 3: displacement sensor, 4: twisted rope, 5: rotary encoder, 6: winch, 7: crown gear coupling, 8: torque sensor, 9: tested component, 10: direction valve, 11: proportional servo direction valve, 12: oil inlet flowmeter, 13: oil outlet flowmeter, 14: loading motor, 15: loading fixed-displacement hydraulic pump, 16: loading proportional relief valve, 17: safety proportional relief valve, 18: variable frequency motor, 19: driving fixed-displacement hydraulic pump, 20: pressure-adjusting proportional relief valve, 21: driving proportional relief valve, 22: flushing motor, 23: flushing fixed-displacement hydraulic pump, and 24: relief valve;

FIG. 2 is a principle diagram for torque loading control; and

FIG. 3 is a principle diagram of a two-stage flow rate controller.

### DETAILED DESCRIPTION OF THE EMBODIMENTS

The present disclosure is described in detail below with reference to the accompanying drawings and with an internal-curve hydraulic motor as a tested example.

As shown in FIG. 1, the present disclosure provides a highly stable and controllable test device for low-speed stability of a hydraulic rotary actuator, including a mechanical system, a hydraulic system, and an electrical system.

The mechanical system includes rack 2, winch 6, twisted rope 4, and crown gear coupling 7. Hydraulic cylinder 1 is disposed on the rack. A stroke of the hydraulic cylinder 1 enables the winch 6 and tested component 9 to complete at least one full rotation. A loading force generated by the hydraulic cylinder 1 is converted by the winch 6 into a loading torque. The hydraulic cylinder 1 is connected to the winch 6 through the twisted rope 4. Torque sensor 8 is connected between the winch 6 and the tested component 9. The crown gear coupling 7 is configured to compensate for possible angular misalignment. The tested component 9 is the internal-curve hydraulic motor.

The hydraulic system includes the hydraulic cylinder 1, the tested component 9, direction valve 10, proportional servo direction valve 11, loading motor 14, loading fixed-displacement hydraulic pump 15, loading proportional relief valve 16, safety proportional relief valve 17, variable frequency motor 18, driving fixed-displacement hydraulic pump 19, pressure-adjusting proportional relief valve 20, driving proportional relief valve 21, flushing motor 22, flushing fixed-displacement hydraulic pump 23, and relief valve 24. The hydraulic system includes a loading circuit of the hydraulic cylinder as well as a drive circuit and a flushing circuit of the internal-curve hydraulic motor. In the loading circuit, the loading motor 14 is connected to the loading fixed-displacement hydraulic pump 15. Hydraulic oil is output by the loading fixed-displacement hydraulic pump 15. A hydraulic pressure is adjusted by the loading proportional relief valve 16. The safety proportional relief valve 17 is connected in parallel to a high-pressure oil line to serve as a safety valve. The direction valve 10 is configured to switch extension and retraction of the hydraulic cylinder. In the drive circuit, the variable frequency motor 18 is connected to the driving fixed-displacement hydraulic pump 19. High-pressure hydraulic oil is input by the driving fixed-displacement hydraulic pump 19 through inlet port A to drive the tested component 9 (the internal-curve hydraulic motor). Low-pressure oil outflows from outlet port C to an oil tank through the driving proportional relief valve 21. The proportional servo direction valve 11 is configured to adjust an input flow rate. The pressure-adjusting proportional relief valve 20 is connected in series to a low-pressure oil line, and configured to adjust an outlet oil pressure of the internal-curve hydraulic motor. Drain port D of the internal-curve hydraulic motor is directly connected to the oil tank via oil outlet flowmeter 13. In the flushing circuit of the internal-curve hydraulic motor, the flushing motor 22 is connected to the flushing fixed-displacement hydraulic pump 23. The flushing fixed-displacement hydraulic pump 23 is configured to provide flushing oil for flushing port F, which can ensure a thermal balance of the internal-curve hydraulic motor in long-period operation. The relief valve 24 is connected in parallel to the flushing fixed-displacement hydraulic pump 23.

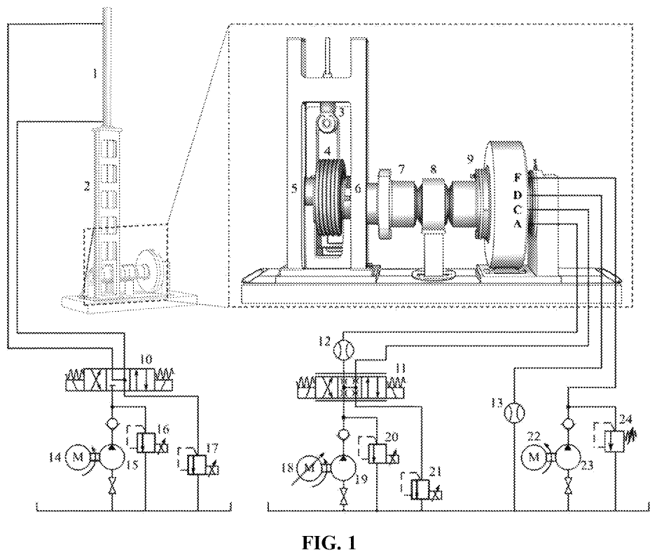

The electrical system includes a load feedback system and a flow rate feedback system. As shown in FIG. 2, the load feedback system includes torque sensor 8 and displacement sensor 3. A loading torque controller is configured to provide loading torque Tₐ, and achieve a needed loading torque with a PID control algorithm according to a feedback signal of loading torque Tₘ measured by the torque sensor 8. Specifically, with the PID control algorithm, valve opening uᵥ₂ of the loading proportional relief valve is controlled, thereby controlling rod chamber pressure pₕ of the hydraulic cylinder to obtain the needed loading torque. In addition, a limit switch is further designed for the hydraulic cylinder according to the displacement of the hydraulic cylinder measured by the displacement sensor 3. The limit switch may be configured to set test stroke xₕ of the hydraulic cylinder. When the hydraulic cylinder reaches a stroke limit xₗᵢₘ, in order not to damage the hydraulic cylinder due to continuous pressure application, a value of the needed loading torque is set as zero. Otherwise, torque Tᵢₙ is output to the PID control algorithm.

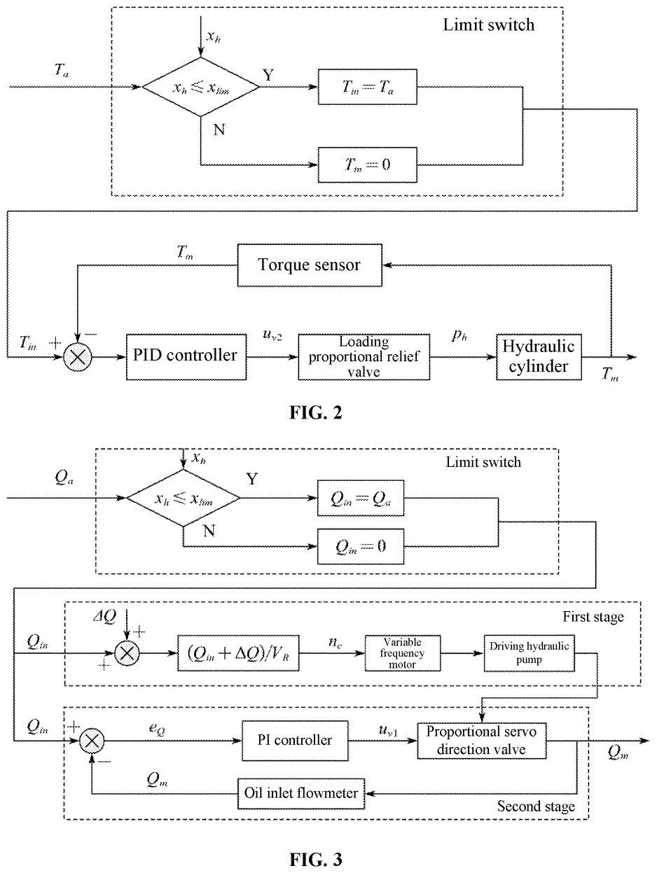

As shown in FIG. 3, the flow rate feedback system includes rotary encoder 5, oil inlet flowmeter 12, and the oil outlet flowmeter 13. In a first stage, desired flow rate Qₐ of a flow rate controller passes through the limit switch to obtain the input flow rate Qᵢₙ. Rotational speed nₑ of the variable frequency motor 18 is determined based on the input flow rate Qᵢₙ, incremental flow rate ΔQ and displacement V_{R} by nₑ=(Qᵢₙ+ΔQ)/V_{R}, thereby enabling the driving fixed-displacement hydraulic pump to output a flow rate. This can ensure that the flow rate provided by the driving fixed-displacement hydraulic pump 19 is always greater than a needed flow rate. With the limit switch, once the loading stroke xₕ of the hydraulic cylinder reaches the stroke limit xₗᵢₘ, in order not to damage the hydraulic cylinder due to continuous pressure application, the input flow rate Qᵢₙ is set as zero. Then, in a second stage, flow rate deviation signal e_{Q} is obtained based on signal Qₘ of the oil inlet flowmeter 12 and the input flow rate Qᵢₙ. Through a PI controller, the flow rate is adjusted to a desired value. A control signal of valve opening uᵥ₁ of the proportional servo direction valve 11 dynamically changes based on a signal of the PI controller, so as to keep the flow rate accurate and stable. Low-speed stability of the hydraulic rotary actuator is specifically tested with the test device provided by the present disclosure as follows:
(1) Load stability is realized. A stable loading torque is provided based on the highly controllable hydraulic winch of the hydraulic cylinder.
(2) Flow rate stability is realized. A proportional servo-hydraulic system is established.
(2.1) The driving fixed-displacement hydraulic pump of a reverse-driven motor is used to replace a variable pump in the traditional test device. The rotational speed of the motor is controlled with the feedback signal of the flow rate. The driving fixed-displacement hydraulic pump outputs the flow rate, thereby reducing flow rate pulsation from the perspective of the component.
(2.2) The two-stage flow rate controller is designed. With the rough adjustment on the hydraulic flow rate in the first stage and the fine adjustment on the hydraulic flow rate in the second stage, the stability of the input flow can be effectively controlled, so as to reduce the flow rate pulsation.
(3) The low-speed stability is tested at high accuracy. The minimum detectable angular change of the rotary encoder 5 is approximately 0.0027°. At an ultra-low speed of 0.01 r/min, the rotation angle of the tested component is about 0.06°/s, which is more than 22 times a resolution angle of the rotary encoder 5. Therefore, the rotary encoder 5 can accurately test the speed stability of the tested component under ultra-low speed conditions.

In another aspect, the present disclosure further provides a highly stable and controllable low-speed stability testing method for a hydraulic rotary actuator, including following steps:
(1) The mechanical system converts the loading force of the hydraulic cylinder in the hydraulic system into the loading torque, and transmits the loading torque to the tested component 9 through the torque sensor 8.
(2) The limit switch is provided, and when the hydraulic cylinder reaches the stroke limit, the value of the needed loading torque and the needed flow rate are set as zero.
(3) Based on the feedback signal of the loading torque Tₘ measured by the torque sensor 8, the loading torque Tₐ provided by the hydraulic cylinder is controlled with the PID control algorithm.
(4) The desired flow rate Qₐ and the needed incremental flow rate ΔQ are determined based on the flow rate at the inlet port and the flow rate at the outlet port, and the rough adjustment is performed on the hydraulic flow rate provided by the hydraulic system.
(5) The flow rate is adjusted to the desired value through the PI controller based on the desired flow rate. The valve opening uᵥ₁ of the proportional servo direction valve is dynamically controlled based on the signal Qₘ of the oil inlet flowmeter 12, so as to maintain the flow rate accurate and stable.

The above described are merely the embodiments of the disclosure and are not intended to constitute a limitation to the scope of the patent of the disclosure. Any equivalent structure or process change made based on the specification and accompanying drawings of the disclosure, or direct or indirect application thereof in other related technical fields, should fall in the protection scope of the patent of the disclosure.

What is claimed is:

1. A highly stable and controllable test device for low-speed stability of a hydraulic rotary actuator, comprising: a mechanical system, a flow rate feedback system, and a load feedback system, wherein
the mechanical system is configured to convert a loading force of a hydraulic cylinder into a loading torque, and transmit the loading torque to a tested component through a torque sensor;
the load feedback system comprises the torque sensor and a displacement sensor; the torque sensor is configured to measure a feedback signal of the loading torque applied to the tested component, and perform feedback control on the loading force provided by the hydraulic cylinder; the displacement sensor is configured to measure a displacement of the hydraulic cylinder; a limit switch is provided to control a stroke of the hydraulic cylinder; the limit switch is configured to set a test stroke of the hydraulic cylinder, and set a value of a needed loading torque and a needed flow rate as zero when the hydraulic cylinder reaches a stroke limit; the flow rate feedback system is configured to determine a desired flow rate and an incremental flow rate based on a flow rate at an inlet port and a flow rate at an outlet port, perform rough adjustment on a hydraulic flow rate provided by the hydraulic cylinder, and then perform fine adjustment on the hydraulic flow rate based on the desired flow rate; specifically, the flow rate feedback system is configured to adjust an output flow rate in two stages; in a first stage, the desired flow rate Qₐ of a flow rate controller passes through the limit switch to obtain an input flow rate Qᵢₙ; a rotational speed nₑ of a variable frequency motor is determined based on the input flow rate Qᵢₙ, the incremental flow rate ΔQ and a displacement V_{R} by nₑ=(Qᵢₙ+ΔQ)/V_{R}, thereby enabling a driving fixed-displacement hydraulic pump to output a flow rate, and ensuring that the flow rate provided by the driving fixed-displacement hydraulic pump is always greater than the needed flow rate; and the limit switch is configured to set the input flow rate Qᵢₙ as zero once a loading stroke xₕ of the hydraulic cylinder reaches the stroke limit xₗᵢₘ; and in a second stage, a flow rate deviation signal e_{Q} is obtained based on a signal Qₘ of an oil inlet flowmeter and the input flow rate Qᵢₙ, and the flow rate is adjusted to a desired value through a proportional-integral (PI) controller; and a control signal of valve opening uᵥ₁ of a proportional servo direction valve dynamically changes based on a signal of the PI controller.

2. The highly stable and controllable test device for the low-speed stability of the hydraulic rotary actuator according to claim 1, wherein the mechanical system further comprises a rack, a winch, a twisted rope, and a crown gear coupling; the hydraulic cylinder is disposed on the rack; the stroke of the hydraulic cylinder enables the winch and the tested component to complete more than one full rotation; the loading force generated by the hydraulic cylinder is converted into the loading torque by the winch; the hydraulic cylinder is connected to the winch through the twisted rope; the winch is connected to the tested component through the torque sensor; and the crown gear coupling is configured to compensate for possible angular misalignment.

3. The highly stable and controllable test device for the low-speed stability of the hydraulic rotary actuator according to claim 1, wherein a hydraulic system comprises a loading circuit of the hydraulic cylinder as well as a drive circuit and a flushing circuit of the tested component;
the loading circuit is configured to output hydraulic oil through a loading fixed-displacement hydraulic pump, wherein a hydraulic pressure is adjusted by a loading proportional relief valve, and extension and retraction of the hydraulic cylinder are switched by a direction valve;
in the drive circuit, high-pressure oil is input by the driving fixed-displacement hydraulic pump to drive the tested component, low-pressure oil outflows to an oil tank, the input flow rate of the hydraulic oil is adjusted by the proportional servo direction valve, and a drain port on the tested component is connected to the oil tank; and
in the flushing circuit, flushing oil is provided for a flushing port of the tested component by a flushing fixed-displacement hydraulic pump, ensuring a thermal balance of the tested component in long-period operation.

4. The highly stable and controllable test device for the low-speed stability of the hydraulic rotary actuator according to claim 3, wherein a safety proportional relief valve is connected in parallel to a high-pressure oil line of the loading circuit to serve as a safety valve.

5. The highly stable and controllable test device for the low-speed stability of the hydraulic rotary actuator according to claim 3, wherein a pressure-adjusting proportional relief valve is connected in series to a low-pressure oil line to adjust an outlet oil pressure of the tested component.

6. The highly stable and controllable test device for the low-speed stability of the hydraulic rotary actuator according to claim 1, wherein the limit switch is provided for the hydraulic cylinder according to the displacement of the hydraulic cylinder measured by the displacement sensor; the limit switch is configured to set the test stroke of the hydraulic cylinder; and when the hydraulic cylinder reaches the stroke limit, in order not to damage the hydraulic cylinder due to continuous pressure application, the value of the needed loading torque is set as zero; otherwise, a torque is output to realize the feedback control.

7. The highly stable and controllable test device for the low-speed stability of the hydraulic rotary actuator according to claim 1, wherein the flow rate feedback system further comprises a rotary encoder configured to measure information on a rotation angle of the tested component.

8. A test method of the highly stable and controllable test device for the low-speed stability of the hydraulic rotary actuator according to claim 1, comprising following steps:
(1) converting, by the mechanical system, the loading force of the hydraulic cylinder in a hydraulic system into the loading torque, and transmitting the loading torque to the tested component through the torque sensor;
(2) providing the limit switch, measuring the displacement of the hydraulic cylinder by the displacement sensor, and when the hydraulic cylinder reaches the stroke limit, setting the value of the needed loading torque and the needed flow rate as zero;
(3) based on the feedback signal of the loading torque measured by the torque sensor, controlling the loading force provided by the hydraulic cylinder with a proportional-integral-derivative (PID) control algorithm;
(4) determining the desired flow rate and the incremental flow rate based on the flow rate at the inlet port and the flow rate at the outlet port, and performing the rough adjustment on the hydraulic flow rate provided by the hydraulic system; and
(5) adjusting the flow rate to the desired value through the PI controller based on the desired flow rate, and dynamically controlling the valve opening of the proportional servo direction valve based on the signal of the oil inlet flowmeter, so as to keep the hydraulic flow rate accurate and stable.

9. The test method according to claim 8, wherein in the highly stable and controllable test device, the mechanical system further comprises a rack, a winch, a twisted rope, and a crown gear coupling; the hydraulic cylinder is disposed on the rack; the stroke of the hydraulic cylinder enables the winch and the tested component to complete more than one full rotation; the loading force generated by the hydraulic cylinder is converted into the loading torque by the winch; the hydraulic cylinder is connected to the winch through the twisted rope; the winch is connected to the tested component through the torque sensor; and the crown gear coupling is configured to compensate for possible angular misalignment.

10. The test method according to claim 8, wherein in the highly stable and controllable test device, the hydraulic system comprises a loading circuit of the hydraulic cylinder as well as a drive circuit and a flushing circuit of the tested component;
the loading circuit is configured to output hydraulic oil through a loading fixed-displacement hydraulic pump, wherein a hydraulic pressure is adjusted by a loading proportional relief valve, and extension and retraction of the hydraulic cylinder are switched by a direction valve;
in the drive circuit, high-pressure oil is input by the driving fixed-displacement hydraulic pump to drive the tested component, low-pressure oil outflows to an oil tank, the input flow rate of the hydraulic oil is adjusted by the proportional servo direction valve, and a drain port on the tested component is connected to the oil tank; and
in the flushing circuit, flushing oil is provided for a flushing port of the tested component by a flushing fixed-displacement hydraulic pump, ensuring a thermal balance of the tested component in long-period operation.

11. The test method according to claim 10, wherein in the highly stable and controllable test device, a safety proportional relief valve is connected in parallel to a high-pressure oil line of the loading circuit to serve as a safety valve.

12. The test method according to claim 10, wherein in the highly stable and controllable test device, a pressure-adjusting proportional relief valve is connected in series to a low-pressure oil line to adjust an outlet oil pressure of the tested component.

13. The test method according to claim 8, wherein in the highly stable and controllable test device, the limit switch is provided for the hydraulic cylinder according to the displacement of the hydraulic cylinder measured by the displacement sensor; the limit switch is configured to set the test stroke of the hydraulic cylinder; and when the hydraulic cylinder reaches the stroke limit, in order not to damage the hydraulic cylinder due to continuous pressure application, the value of the needed loading torque is set as zero; otherwise, a torque is output to realize the feedback control.

14. The test method according to claim 8, wherein in the highly stable and controllable test device, the flow rate feedback system further comprises a rotary encoder configured to measure information on a rotation angle of the tested component.
